(19) United States
(12) Patent Application Publication
(10) Pub. No.: US 2021/0081491 A1
(43) Pub. Date: Mar. 18, 2021

(54) INFORMATION PROCESSING APPARATUS, CONTROL METHOD, AND PROGRAM

(71) Applicant: NEC Corporation, Minato-ku, Tokyo (JP)

(72) Inventors: Osamu DAIDO, Tokyo (JP); Takuya ARAKI, Tokyo (JP)

(73) Assignee: NEC Corporation, Minato-ku, Tokyo (JP)

(21) Appl. No.: 16/963,686

(22) PCT Filed: Jan. 21, 2019
(86) PCT No.: PCT/JP2019/001656

§ 371 Date: Jul. 21, 2020

(30) Foreign Application Priority Data
Jan. 31, 2018 (JP) 2018-015598

(51) Int. Cl. G06F 17/16; G06F 9/38; G06N 20/00

(52) U.S. Cl. CPC G06F 17/16; G06N 20/00; G06F 9/3887

(57) ABSTRACT

An information processing apparatus (2000) acquires a plurality of data (10). The information processing apparatus (2000) generates a first matrix (20) representing groups, to which each data (10) belongs, in a classification according to a first reference. The information processing apparatus (2000) generates a second matrix (30) representing groups, to which each data (10) belongs, in a classification according to a second reference. The information processing apparatus (2000) computes a scalar product of the first matrix (20) and the second matrix (30), and, for each combination of the groups of the first reference and the groups of the second reference, computes the number of data (10) included in the combination.

### TECHNICAL FIELD

The present invention relates to parallel processing.

### BACKGROUND ART

A large amount of data is required to be processed at high speed. One of techniques for speeding up data processing is parallelization of processing. For example, it is possible to unroll and process in parallel a repetitive process in which it is possible to independently handle a plurality of data.

A document which discloses a technique for processing data in parallel includes, for example, Patent Document 1. Patent Document 1 discloses an invention of a Single Instruction Multiple Data (SIMD)-type processor. The SIMD is a form of parallel processing that speeds up a process by executing one instruction with respect to a plurality of data simultaneously. An example of the SIMD-type processor includes a Graphics Processing Unit (GPU).

### RELATED DOCUMENT

### Patent Document

[Patent Document 1] Japanese Patent Application Publication No. 2015-191463

### Non-Patent Documents

[Non-Patent Document 1] Toby Segaran, “Programming Collective Intelligence”, O'Reilly Japan, Jul. 23, 2008, pp. 155-180

### SUMMARY OF THE INVENTION

### Technical Problem

In order to execute a data processing program at high speed, it is preferable to perform parallelization as many processes included in the data processing program as possible. However, there are some data processing which are difficult to be parallelized. For example, in one repetitive process, it is difficult to parallelize a process in which an operation result of data to be processed first is used for an operation of data to be processed later. Patent Document 1 does not disclose a method of parallelizing the data processing program.

The present invention has been made in view of the above problems, and one of its objects is to provide a new technique for parallelizing data processing.

### Solution to Problem

An information processing apparatus according to the present invention includes: 1) an acquisition unit which acquires a plurality of data, 2) a first matrix generation unit which generates a first matrix representing which group each of the data belongs to in a classification according to a first reference, 3) a second matrix generation unit which generates a second matrix representing which group each of the data belongs to in a classification according to a second reference, and 4) a product computation unit which computes, for each combination of groups of the first reference and groups of the second reference, the number of the data belonging to the combination by computing a scalar product of the first matrix and the second matrix.

A control method according to the present invention is executed by a computer. The control method includes: 1) an acquisition step of acquiring a plurality of data, 2) a first matrix generation step of generating a first matrix representing which group each of the data belongs to in a classification according to a first reference, 3) a second matrix generation step of generating a second matrix representing which group each of the data belongs to in a classification according to a second reference, and 4) a product computation step of computing, for each combination of groups of the first reference and groups of the second reference, the number of the data belonging to the combination by computing a scalar product of the first matrix and the second matrix.

A program according to the present invention causes a computer to execute each step of the control method according to the present invention.

### Advantageous Effects of Invention

According to the present invention, a new technique for parallelizing data processing is provided.

### BRIEF DESCRIPTION OF THE DRAWINGS

The above and other objects, features and advantages will become more apparent from the preferred example embodiments described below and the accompanying drawings.

FIG. 1 is a diagram conceptually illustrating a process performed by an information processing apparatus according to a first example embodiment.

FIG. 2 is a diagram illustrating a matrix generated by the information processing apparatus.

FIG. 3 is a diagram illustrating an aspect in which a scalar product of a first matrix and a second matrix is computed.

FIG. 4 is a diagram illustrating a functional configuration of the information processing apparatus according to the first example embodiment.

FIG. 5 is a diagram illustrating a computer for realizing the information processing apparatus.

FIG. 6 is a flowchart illustrating a flow of the process executed by the information processing apparatus according to the first example embodiment.

FIG. 7 is a flowchart illustrating a flow of a process of generating the first matrix.

FIG. 8 is a flowchart illustrating a flow of a process of generating the second matrix.

FIG. 9 is a diagram illustrating a variation on a method of computing a product of the first matrix and the second matrix.

FIG. 10 is a diagram illustrating the variation on the method of computing the product of the first matrix and the second matrix.

FIG. 11 is a diagram illustrating the variation on the method of computing the product of the first matrix and the second matrix.

FIG. 12 is a diagram illustrating a decision tree.

FIG. 13 is a diagram illustrating computation of a result matrix 40 indicating C[S[k], L[j]].

FIG. 14 is a diagram illustrating the first matrix collectively generated for a plurality of division patterns.

FIG. 15 is a diagram illustrating an aspect in which C[S[p][k], L[j]] is indicated for the plurality of division patterns in one result matrix 40.

FIG. 16 is a diagram illustrating a correspondence relationship between a first matrix realized as a bit vector integer array V1 and a first matrix realized as an integer array I1.

FIG. 17 is a diagram illustrating a method of realizing the product of the first matrix and the second matrix using a bit operation.

### DESCRIPTION OF EMBODIMENTS

Hereinafter, example embodiments of the present invention will be described with reference to the drawings. Also, throughout the drawings, the same components are denoted by the same reference numerals, and description thereof will not be repeated. In addition, unless otherwise specified, in each block diagram, each block represents a configuration in a functional unit instead of a configuration in a hardware unit.

### First Example Embodiment

<Overview>

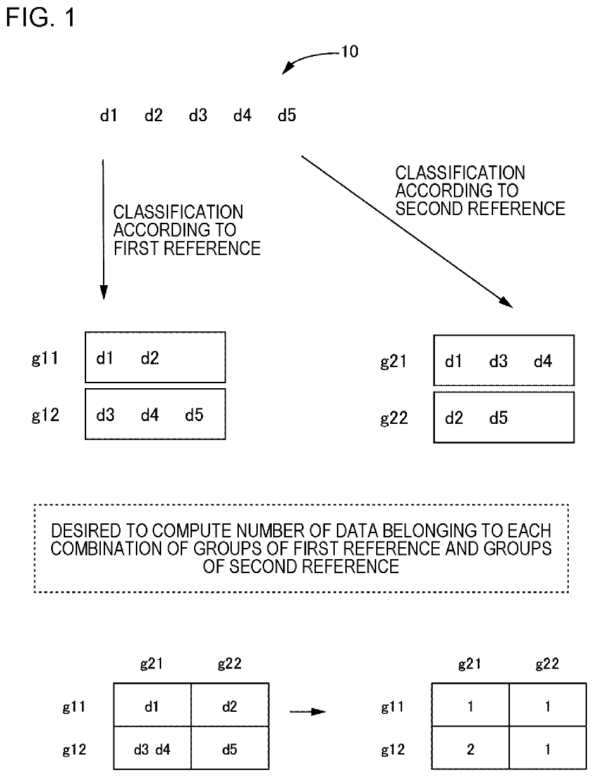

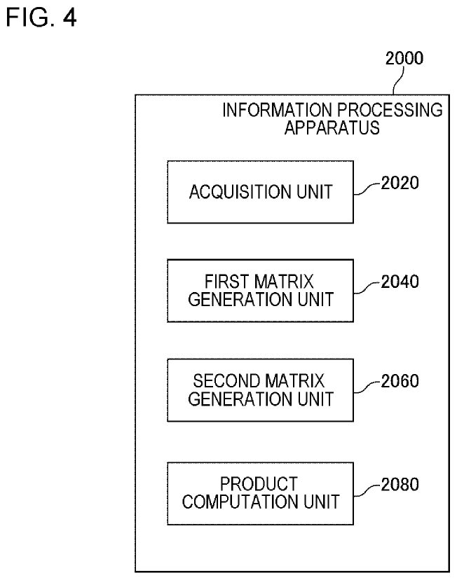

FIG. 1 is a diagram conceptually illustrating a process performed by an information processing apparatus (an information processing apparatus 2000 illustrated in FIG. 4) according to the present example embodiment. An information processing apparatus 2000 acquires a plurality of data 10. For example, the data 10 is learning data to be learned through machine learning.

It is possible to classify each data 10 by two different references. Hereinafter, the two different references are referred to as a first reference and a second reference, respectively. In FIG. 1, the data 10 (d1 to d5) is divided into two groups g11 and g12 of the first reference. In addition, the data 10 is divided into two groups g21 and g22 of the second reference.

The information processing apparatus 2000 computes, for each of combinations of the groups of the first reference and the groups of the second reference, the number of data 10 included in each of the combinations. For example, in an example of FIG. 1, four combinations including 1) g11 and g21, 2) g11 and g22, 3) g12 and g21, and 4) g12 and g22 exist as the combinations of the groups of the first reference and the groups of the second reference. Further, the number of data 10 included in each of the combinations is one, one, two, and one, respectively.

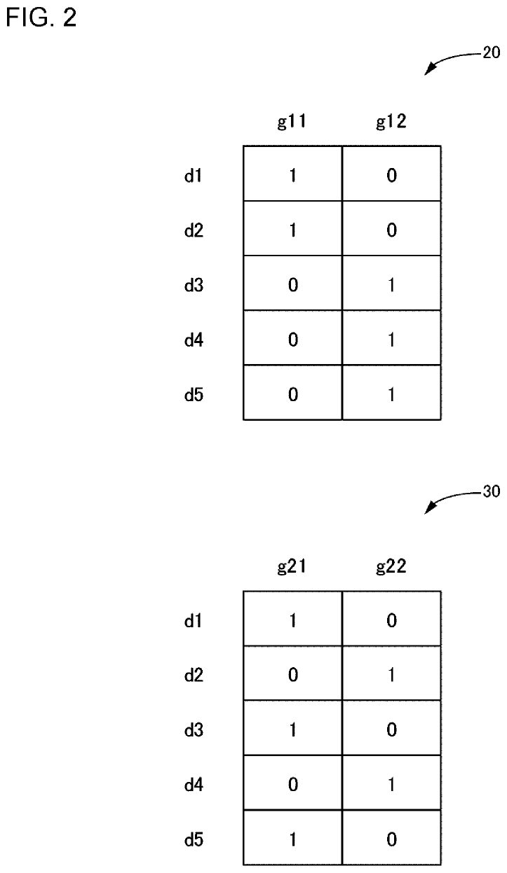

The information processing apparatus 2000 realizes a process of computing the number of data 10 included in each of the combinations of first groups and second groups, described above, as a matrix operation. In this manner, it is possible to perform parallel processing. First, the information processing apparatus 2000 generates a matrix (hereinafter, a first matrix) representing the groups, to which each data 10 belongs, of the first reference. FIG. 2 is a diagram illustrating the matrix generated by the information processing apparatus 2000. Respective columns of a first matrix 20 correspond to groups, which are different from each other, of the first references, respectively. In FIG. 2, the first matrix 20 includes two columns. A first column is a column indicating whether or not the data 10 belongs to the group g11 of the first reference. A second column is a column indicating whether or not the data 10 belongs to the group g12 of the first reference.

Each row of the first matrix 20 indicates, for each of the different data 10, the groups, to which the data 10 belongs, of the first references. Specifically, the row of the first matrix 20 indicates 1 only for any one of the columns and indicates 0 for the other columns, thereby representing that the data 10 belongs to the group of the first reference corresponding to the column having a value of 1. For example, a first row of the first matrix 20 has a value of 1 for the first column and has a value of 0 for the second column. Therefore, the first row of the first matrix 20 represents that the first data 10 (data d1) belongs to the group g11 of the first reference. Similarly, the information processing apparatus 2000 generates a matrix (hereinafter, a second matrix 30) representing the groups, to which each data 10 belongs, of the second reference.

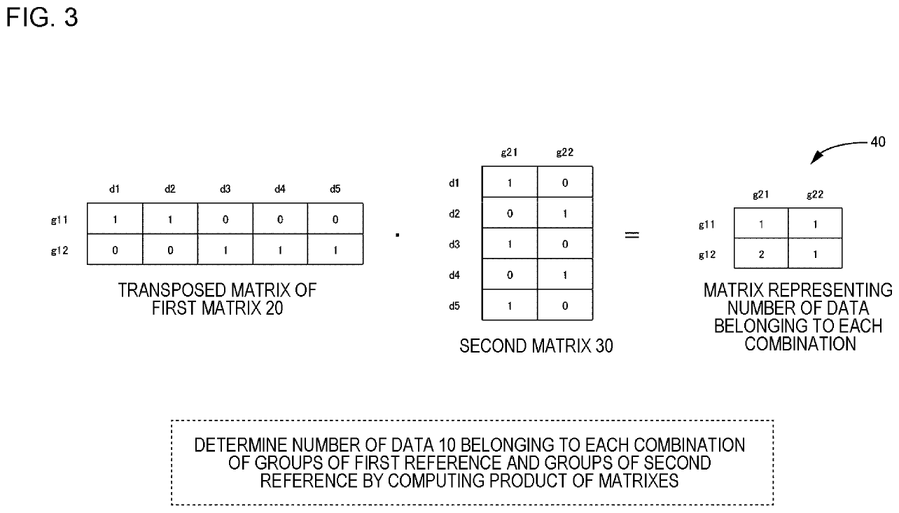

Further, the information processing apparatus 2000 computes a scalar product of the first matrix 20 and the second matrix 30. FIG. 3 is a diagram illustrating an aspect in which the scalar product of the first matrix 20 and the second matrix 30 is computed. In FIG. 3, the information processing apparatus 2000 multiplies a transposed matrix of the first matrix 20 by the second matrix 30. Reference numeral 40 represents a result matrix 40 generated as a result of the scalar product. As will be described below, each element of the result matrix 40 represents the number of data 10 belonging to each of the combinations of the groups of the first reference and the groups of the second reference.

The following Equation (1) represents a product pij of an i-th row of the transposed matrix of the first matrix and a j-th column of the second matrix. pij is a value of an i-th row and a j-th column of the result matrix 40.

$${p}_{i , j} = {\sum }_{k} {f}_{i , k}^{′} * {s}_{k , j} \qquad ( 1 )$$

Note that, fik is a value of an i-th row and a k-th column of the transposed matrix of the first matrix 20, and skj is a value of a k-th row and a j-th column of the second matrix 30.

A product of the i-th row and the k-th column of the transposed matrix of the first matrix 20 and the k-th row and the j-th column of the second matrix 30 is 1 only in a case where both of the i-th row and the k-th column of the transposed matrix of the first matrix 20 and the k-th row and the j-th column of the second matrix 30 are 1. Here, the i-th row and the k-th column of the transposed matrix of the first matrix 20 correspond to a k-th row and an i-th column of the first matrix 20. Therefore, a fact that the i-th row and the k-th column of the transposed matrix of the first matrix 20 is 1 means that k-th data 10 belongs to an i-th group of the first reference. On the other hand, a fact that the k-th row and the j-th column of the second matrix is 1 means that the k-th data 10 belongs to the j-th group of the second reference. From above, the product of the i-th row and the k-th column of the transposed matrix of the first matrix 20 and the k-th row and the j-th column of the second matrix 30 becomes 1 only in a case where the k-th data 10 belongs to the i-th group of the first reference and belongs to the j-th group of the second reference. Therefore, it is possible to compute the number of data 10 belonging to the i-th group of the first reference and belonging to the j-th group of the second reference using Equation (1).

From above, with the result matrix 40 obtained as a result of computing the product of the transposed matrix of the first matrix 20 and the second matrix 30, it is possible to obtain, for each of the combinations of the groups of the first reference and the groups of the second reference, the number of data 10 included in the combination (refer to FIG. 3).

Note that, although description will be performed in detail later, a method of computing the product of the first matrix 20 and the second matrix 30 is not limited to a method of multiplying the transposed matrix of the first matrix 20 by the second matrix 30.

In addition, the values set for the first matrix 20 and the second matrix 30 are not limited to 0 and 1. For example, considering a suitable ring having a sufficiently large order, a zero factor may be used instead of 0 and an appropriate non-zero factor, such as a unit element, may be used instead of 1. A specific case where values other than 0 and 1 are set for the first matrix 20 and the second matrix 30 will be described later.

<Operations and Effects>

The information processing apparatus 2000 according to the present example embodiment computes, for the combinations of the first groups obtained by performing classification on the data 10 according to the first reference and the second groups obtained by performing classification on the data 10 according to the second reference, the number of data 10 belonging to each of the combinations. Generally, a process of computing the number of data belonging to each of the plurality of groups is realized by a counting process using a counter variable. Specifically, the counter variable is prepared for each group, and a repetitive process of “deciding a group to which the data belongs and adding 1 to the counter variable of the group which is decided that the data belongs” is executed for each data.

In a case where the repetitive process of updating the counter variable is unrolled and parallelized, the counter variable is shared by a plurality of processes and threads. Therefore, there is a possibility that data inconsistency occurs because the plurality of processes or the like try to update the counter variable at the same time, and thus it is not possible to realize parallelization by simple unrolling.

As one method of parallelizing the process of computing the number of data belonging to the group using the counter variable, there is a method of performing exclusive control in access to the counter variable. However, in the method, since only one process or the like can access the counter variable at a time, and thus an effect of reducing a time required for data processing is reduced.

In this regard, as will be described later, the process executed by the information processing apparatus 2000 according to the present example embodiment enables parallelization without performing the exclusive control. Therefore, according to the information processing apparatus 2000, it is possible to significantly reduce the time required for the data processing.

As another method of parallelizing the process of computing the number of data belonging to the group using the counter variable, a method of providing a separate counter variable for each process or the like so that the counter variable is not shared may be considered. However, in the method, it is necessary to increase the number of counter variables as the number of parallelization increases, and thus consumption of a storage area, such as a memory or a storage device, increases.

In this regard, in the information processing apparatus 2000 according to the present example embodiment, it is not necessary to prepare the counter variable for each process or the like. Therefore, it is possible to reduce the consumption of the storage area, compared to the above-described method.

Hereinafter, the information processing apparatus 2000 according to the present example embodiment will be described in more detail.

<Example of Functional Configuration of Information Processing Apparatus 2000>

FIG. 4 is a diagram illustrating a functional configuration of the information processing apparatus 2000 according to a first example embodiment. The information processing apparatus 2000 includes an acquisition unit 2020, a first matrix generation unit 2040, a second matrix generation unit 2060, and a product computation unit 2080. The acquisition unit 2020 acquires the plurality of data 10. The first matrix generation unit 2040 generates the first matrix 20. The first matrix 20 represents which group each of the data 10 belongs to in a classification according to the first reference. The second matrix generation unit 2060 generates the second matrix 30. The second matrix 30 represents which group each of the data 10 belongs to in a classification according to the second reference. The product computation unit 2080 computes the product of the first matrix 20 and the second matrix 30 to compute the number of data 10 belonging to each of the combinations of the groups of the first reference and the groups of the second reference.

<Hardware Configuration of Information Processing Apparatus 2000>

Each functional component of the information processing apparatus 2000 may be realized by hardware (for example, a hard-wired electronic circuit or the like) that realizes each functional component, or a combination of the hardware and software (for example, a combination of an electronic circuit and a program for controlling the same). Hereinafter, a case where each functional component of the information processing apparatus 2000 is realized by the combination of the hardware and the software will be further described.

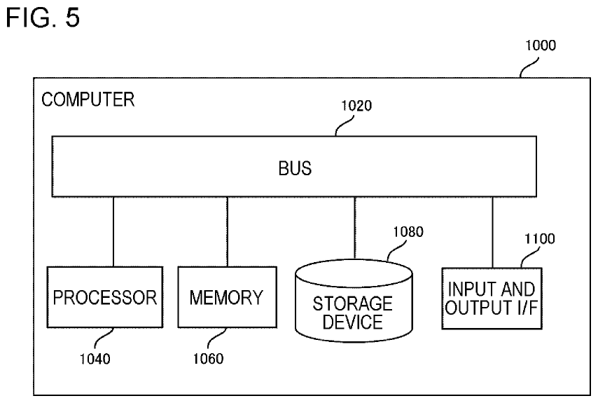

FIG. 5 is a diagram illustrating a computer 1000 for realizing the information processing apparatus 2000. The computer 1000 is an arbitrary computer. For example, the computer 1000 is a Personal Computer (PC), a server machine, or the like. The computer 1000 may be a dedicated computer designed to realize the information processing apparatus 2000, or may be a general-purpose computer.

The computer 1000 includes a bus 1020, a processor 1040, a memory 1060, a storage device 1080, and an input and output interface 1100. The bus 1020 is a data transmission path through which the processor 1040, the memory 1060, the storage device 1080, and the input and output interface 1100 mutually transmit and receive data. However, a method of connecting the processor 1040 and the like to each other is not limited to bus connection.

The processor 1040 includes various processors such as a Central Processing Unit (CPU), a Field-Programmable Gate Array (FPGA), and a Graphics Processing Unit (GPU). Here, the information processing apparatus 2000 performs the parallel processing of the data processing. A method of using a SIMD-type processor, such as a GPU, is one method of realizing the parallel processing. In a case where the information processing apparatus 2000 performs the parallel processing using the SIMD-type processor, the processor 1040 may be used as the SIMD-type processor, or the SIMD-type processor may be provided as a processor separated from the processor 1040. In the latter case, for example, the information processing apparatus 2000 causes the SIMD-type processor to execute an operation in which it is possible to perform the parallel processing, and causes the processor 1040 to execute the other operations.

Note that, the method of realizing the parallel processing is not limited to the method using the SIMD type processor. For example, the parallel processing may be realized in a form such as parallelization between processor cores or parallelization between the computers. Therefore, it is not necessary that the information processing apparatus 2000 essentially includes the SIMD-type processor.

The memory 1060 is a main storage realized using a Random Access Memory (RAM) or the like. The storage device 1080 is an auxiliary storage realized using a hard disk, a Solid State Drive (SSD), a memory card, a read Only Memory (ROM), or the like.

The input and output interface 1100 is an interface for connecting the computer 1000 to an input and output device. For example, an input apparatus, such as a keyboard, and an output apparatus, such as a display apparatus, are connected to the input and output interface 1100.

The storage device 1080 stores program modules that realize respective functional components of the information processing apparatus 2000. The processor 1040 realizes functions corresponding to the respective program modules by reading out the respective program modules into the memory 1060 and executing the program modules.

<Process Flow>

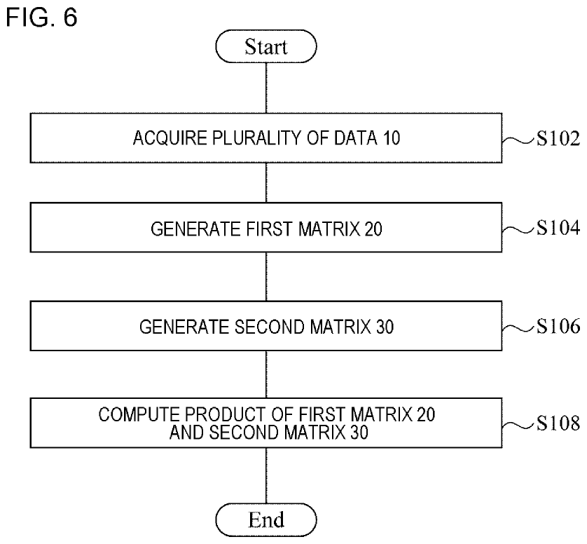

FIG. 6 is a flowchart illustrating a flow of a process executed by the information processing apparatus 2000 according to the first example embodiment. The acquisition unit 2020 acquires the data 10 (S102). The first matrix generation unit 2040 generates the first matrix 20 (S104). The second matrix generation unit 2060 generates the second matrix 30 (S106). The product computation unit 2080 computes the product of the first matrix and the second matrix (S108). Here, it is not necessary to perform the generation of the first matrix 20 and the generation of the second matrix 30 in this order. In addition, the processes may be executed in parallel.

<Acquisition of Data 10: S102>

The acquisition unit 2020 acquires the data 10 (S102). Here, there are various methods of the information processing apparatus 2000 acquiring the data 10. For example, the acquisition unit 2020 acquires the data 10 from a storage apparatus in which the data 10 is stored. The storage apparatus in which the data 10 is stored may be provided on an inside of the information processing apparatus 2000 or may be provided on an outside thereof. Alternatively, for example, the acquisition unit 2020 may acquire the data 10 by receiving the data 10 transmitted by another apparatus.

<Generation of First Matrix 20: S104>

The first matrix generation unit 2040 generates the first matrix 20. As described above, the first matrix 20 is a matrix representing which group of the first reference each of the data 10 belongs to. For example, the first matrix generation unit 2040 generates the first matrix 20 according to a flow which will be described below.

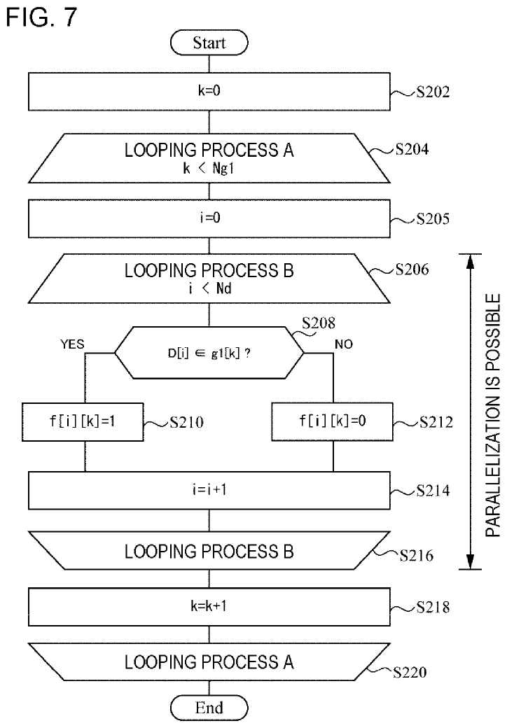

FIG. 7 is a flowchart illustrating a flow of a process of generating the first matrix 20. The first matrix generation unit 2040 initializes a group number k to 0 (S202). A looping process A performed on each group g1 [k] includes steps S204 to S220. In S204, the first matrix generation unit 2040 decides whether or not a value of the group number k is smaller than the total number Ng1 of groups of the first reference. In a case where k is smaller than Ng1, the process in FIG. 7 proceeds to S205. On the other hand, in a case where k is equal to or larger than Ng1, the process in FIG. 7 ends.

In S205, the first matrix generation unit 2040 initializes a data number i to 0. A looping process B performed on each data 10 included in a permutation D of the data 10 includes steps S206 to S216. In S206, the first matrix generation unit 2040 decides whether or not the data number i is smaller than the number Nd of the data 10. In a case where i is smaller than Nd, the process in FIG. 7 proceeds to S208. On the other hand, in a case where i is equal to or larger than Nd, the process in FIG. 7 proceeds to S218.

In S208, the first matrix generation unit 2040 decides whether or not D[i] that is the i-th data 10 is included in g1 [k] that is a k-th group of the first reference. In a case where D[i] is included in g1 [k] (S208: YES), the first matrix generation unit 2040 sets f[i][k], which is a value of an i-th row and a k-th column of the first matrix 20, to 1 (S210). On the other hand, in a case where D[i] is not included in g1 [k] (S208: NO), the first matrix generation unit 2040 sets f[i][k] to 0 (S212).

In S214, the first matrix generation unit 2040 adds 1 to i. Since S216 is an end of the looping process B, the process in FIG. 7 proceeds from S216 to S206.

In S218, the first matrix generation unit 2040 adds 1 to k. Since S220 is an end of the looping process A, the process in FIG. 7 proceeds from S218 to S204.

Here, in the looping process B (S206 to S216), there is no process of accessing the shared variable, and thus it is possible to perform parallelization without performing the exclusive control. Therefore, it is possible to execute the looping process B at high speed by performing parallel processing through unrolling.

<<Method of Expressing Matrix in Computer Program>>

Here, in a case where a matrix is expressed by a computer program, a two-dimensional array of variables (for example, integer-type or float-type variables) of a type capable of storing numerical values is prepared and each element of the matrix corresponds to each element of the array. For example, the information processing apparatus 2000 prepares a two-dimensional array f[ ][ ] and stores a value of an i-th row and a j-th column of the first matrix 20 in f[i][j]. That is, one variable is prepared for each element of the first matrix 20. As a result, one register is used for each element of the matrix in the processor.

However, it is not necessary that one variable is essentially prepared for each element of the matrix. That is, a plurality of elements of the matrix may correspond to one variable. A specific method of realizing a case where the plurality of elements of the matrix correspond to one variable will be described as a second example embodiment.

<Generation of Second Matrix 30: S106>

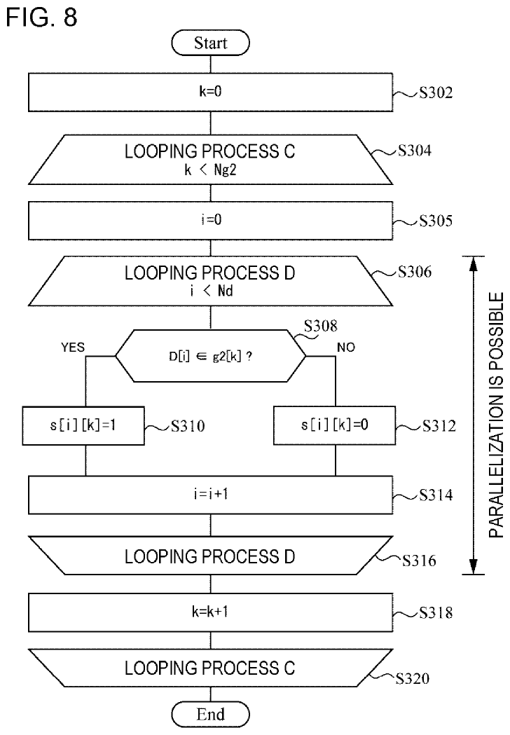

The second matrix generation unit 2060 generates the second matrix 30. Here, a method of generating the second matrix 30 is the same as the method of generating the first matrix 20. FIG. 8 is a flowchart illustrating a flow of a process of generating the second matrix 30. In FIG. 8, g2[k] represents a k-th group of the second reference, Ng2 represents the total number of groups of the second reference, and s[i][k] represents a value of an i-th row and a k-th column of the second matrix 30.

Here, similarly to the looping process B in FIG. 7, it is possible to perform parallelization on processes in a looping process D (S306 to 3216) in FIG. 8 without performing the exclusive control. Accordingly, it is possible to execute the looping process D at high speed by performing the parallel processing through unrolling.

<Computation of Product: S108>

The product computation unit 2080 obtains the result matrix 40 by computing the product of the first matrix 20 and the second matrix 30 (S108). The result matrix 40 indicates the number of data 10 included in each of the combinations of the groups of the first reference and the groups of the second reference (refer to FIG. 3).

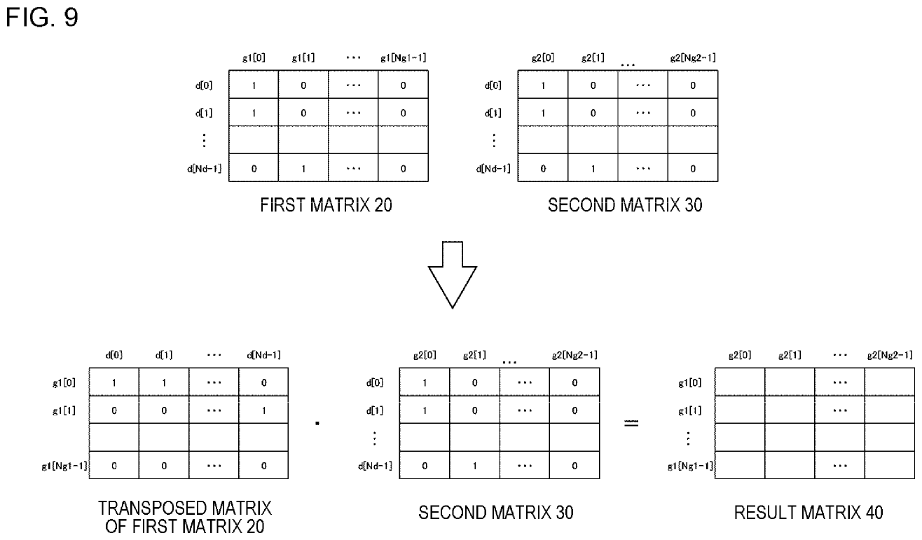

The method of computing the product of the first matrix 20 and the second matrix 30 depends on configurations of the first matrix 20 and the second matrix 30. FIGS. 9 to 11 are diagrams illustrating variations on the method of computing the product of the first matrix 20 and the second matrix 30. In FIG. 9, respective rows of the first matrix 20 indicate information relevant to the data 10 which are different from each other, and respective rows of the second matrix 30 indicate information relevant to the data 10 which are different from each other. In this case, the product computation unit 2080 transposes the matrix to be multiplied from the left. For example, in FIG. 9, since the first matrix 20 is on a left side, a transposed matrix of the first matrix 20 is generated, and the transposed matrix of the first matrix 20 is multiplied by the second matrix 30 from the right. However, the second matrix 30 may be on the left side such that a transposed matrix of the second matrix 30 is multiplied by the first matrix 20 from the right.

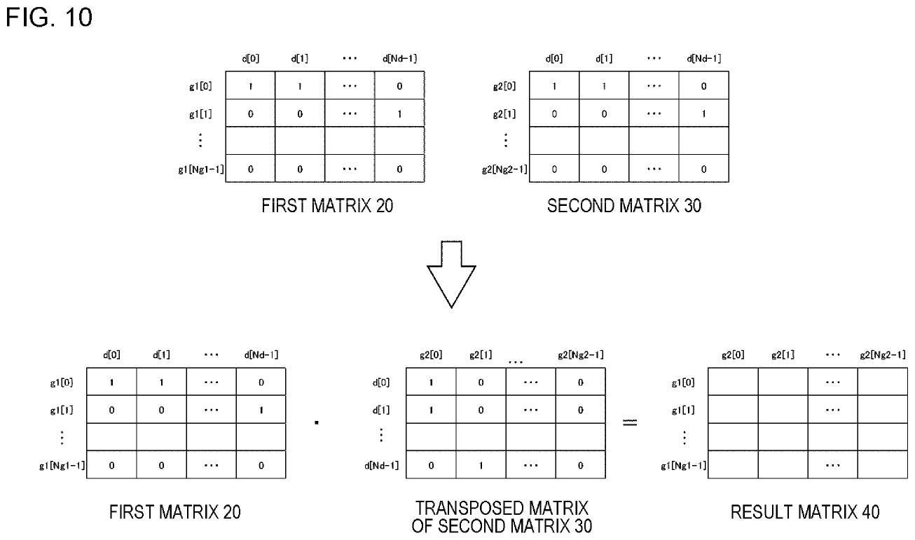

In FIG. 10, respective columns of the first matrix 20 indicate information relevant to the data 10 which are different from each other, and respective columns of the second matrix 30 indicate information relevant to the data 10 which are different from each other. In this case, a matrix on a right side is transposed. In FIG. 10, the second matrix 30 on the right side is transposed.

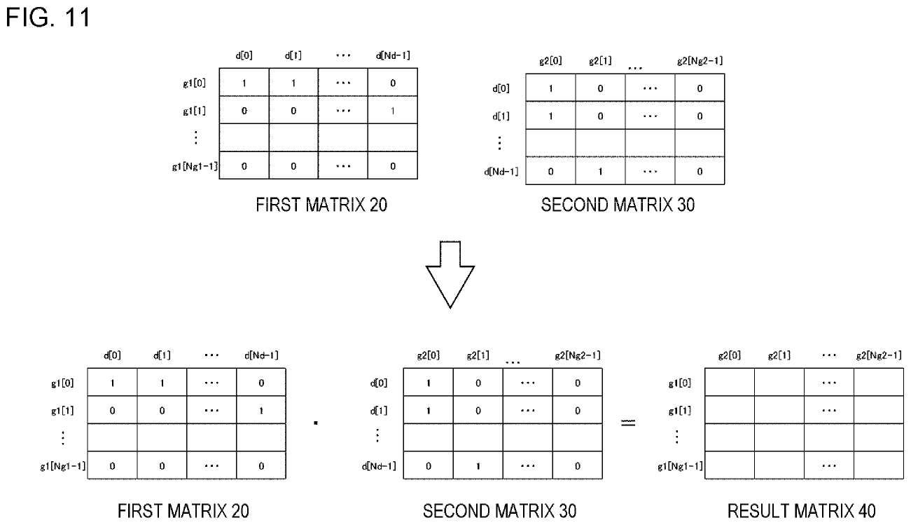

In FIG. 11, respective columns of the first matrix 20 indicate information relevant to the data 10 which are different from each other, and respective rows of the second matrix 30 indicate information relevant to the data 10 which are different from each other. That is, the configuration of first matrix 20 in FIG. 11 is the same as the configuration of first matrix 20 obtained after transposition in FIG. 9. In this case, it is not necessary to transpose the first matrix 20 or the second matrix 30, and it is possible to compute the product of the first matrix 20 and the second matrix 30 by multiplying the first matrix 20 by the second matrix 30 from the right.

<Specific Method of Parallel Processing>

The information processing apparatus 2000 performs the parallel processing on at least a part of the process of computing the product of the first matrix 20 and the second matrix 30. For example, one or more products “f[i][k] *s[k][j]” between the elements of the matrixes indicated by Equation (1) are executed in parallel. Note that, since the computation of the product is independent from all i, j, and k, for example, the information processing apparatus 2000 may execute the product “f[i][k] *s[k][j]” for all combinations of i, j, and k in parallel. In addition, as indicated in Equation (1), a result of the computation of the product is integrated for each of the combinations of i and j. Here, for example, the information processing apparatus 2000 may perform the parallel processing on the computation of the product, which is performed for each of a plurality of combinations of i and j.

In addition, as described above, the information processing apparatus 2000 may perform the parallel processing on the looping process B in the generation of the first matrix 20 or may perform the parallel processing on the looping process D in the generation of the second matrix 30. Note that, it is possible to use an existing method as a specific method of parallelizing the repetitive process. For example, it is possible to unroll the repetitive process to the parallel processing by a compiler.

<Usage Example>

In order to more specifically describe the information processing apparatus 2000, a usage example of the information processing apparatus 2000 will be described. Note that, the following description is merely an example of a method of utilizing the information processing apparatus 2000, and does not limit a utilizing range of the information processing apparatus 2000.

In the usage example, the machine learning is performed using a decision tree model. The data 10 is a learning sample in which a label is attached to a column of one or more attribute data. The attribute is information used as a basis for prediction, and is also called a feature value, an explanatory variable, or the like. The label represents data to be output in a case where the learning sample is input to a learned model.

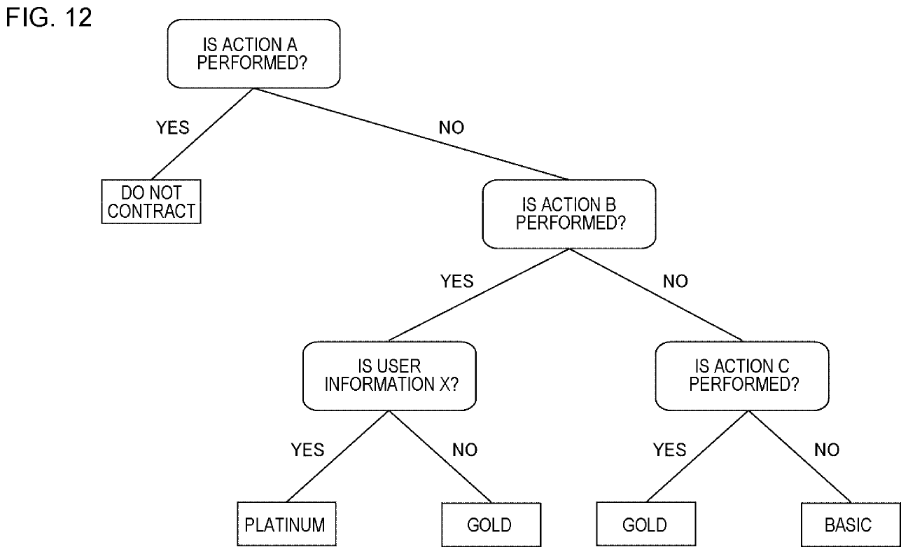

FIG. 12 is a diagram illustrating a decision tree. The decision tree is a model that predicts a service selected by a new user after a fixed period of use elapses in a web service in which a plurality of service classes are prepared. Since platinum, gold, and basic service classes are prepared as the service classes, the user has four options including 1) a contract with platinum, 2) a contract with gold, 3) a contract with basic, and 4) do not contract.

The learning sample (data 10) used to generate the decision tree model is data relevant to the user who already performs the above selection, and indicates information relevant to the user and user behavior during the period of use as attribute data, and indicates the selection performed by the user as a correct answer label.

There are various decision tree learning algorithms. For example, Non-Patent Document 1 discloses an example of a classical decision tree learning algorithm. A core process for constructing the decision tree is a process of dividing a learning sample group into groups including partial learning data without duplication or omission and evaluating a quality of the division. The quality of the division is decided according to which labels and how many labels are included in the learning sample group obtained before the division and the partial learning sample groups obtained after the division.

Here, a reference for evaluating the quality of the division performed on the learning sample group is “a best division is division, in which an information gain is the largest before and after the division is performed, in a case where the learning sample group is divided into groups by a certain threshold value having certain attribute data”. The information gain is a measure of a difference in probability distribution.

A case where a learning sample group S is divided into K learning sample groups {S[1], S[2], . . . , S[K]}, that is, a case where a K-ary tree is constructed is took into consideration. In a case where any function F of computing “an impurity of a label” included in the learning sample group is used, an information gain D is represented by the following Equation (2).

$$D = F ( S ) - {\sum }_{k = 1}^{K} \frac{N [ k ] \times F ( S [ k ] )}{N} \qquad ( 2 )$$

N[k] represents the number of learning data included in a learning sample group S[k]. N represents the total number of learning samples.

A first term on a right side of Equation (2) is the impurity of the label included in the learning sample group obtained before the division, and a sum of a second term is a weighted average of impurities of labels included in respective learning sample groups obtained after the division. Note that, a case where the information gain D is equal to or smaller than zero means that it is not possible to divide the learning sample group any more.

The impurity of the label is an index decided by types of the labels included in the learning data and the number of appearances, and a measure called Gini impurity or information entropy is used in actual computation.

For example, it is assumed that M types of labels exist for the learning sample group S including N learning samples and the number of appearances of a j-th label L[j] is C[S, L[j]] (1≤j≤M). At this time, a Gini impurity G(S) of the learning sample group S is represented by Equation (3). In addition, an information entropy H(S) is represented by Equation (4).

$$G ( S ) = {\sum }_{j = 1}^{M} \frac{C [ S , L [ j ] ]}{N} ( {\sum }_{l \neq j} \frac{C [ S , L [ l ] ]}{N} ) \qquad ( 3 )$$

$$H ( S ) = - {\sum }_{j = 1}^{M} \frac{C [ S , L [ j ] ]}{N} log \frac{C [ S , L [ j ] ]}{N} \qquad ( 4 )$$

In general, it is necessary to count the number C[S, L[j]] of appearances of each label by a repetitive process throughout the entire learning samples included in the learning sample group S. Classically, whenever one node of the decision tree is constructed, it is necessary to detect the best division by trying the combinations of all the attributes and all the threshold values included in the learning data. Therefore, a process of counting the number of appearances of the label is a frequent process that needs to be performed each time whenever a new node is added to the decision tree and whenever a combination of the attribute and the threshold value changes.

Generally, counting of the number of appearances of the label is realized by a repetitive process of preparing the counter variable and updating the counter variable whenever the label to be counted appears. However, as described above, it is difficult to simply parallelize the process of counting the counter variable, and thus exclusive control and the like is necessary.

Here, a label impurity F(S[k]) included on the right side of Equation (2) is computed for each learning sample group S[k] generated by dividing the attribute data by the threshold value. Therefore, it is possible to represent the number of a j-th label L[j] in the computation of the impurity F(S[k]) of the label as C[S[k], L[j]]. In a case where the information gain D is computed, it is necessary to compute C[S[k], L[j]] for all combinations of k and j.

C[S[k], L[j]] may be the number of learning samples which satisfy a condition of belonging to 1) a k-th group S[k] in groups obtained through division according to the first reference in which the attribute data is divided by the threshold value and belonging to 2) a j-th group L[j] in groups obtained through the division according to the second reference of the label. Therefore, computation of C[S[k], L[j]] for all combinations of k and j is equal to computation of the number of learning samples included in each of the combinations of 1) the group S[k] obtained through division according to the first reference in which the attribute data is divided by the threshold value and 2) the group L[j] obtained through division according to the second reference of the label. Therefore, it is possible to realize a process of computing C[S[k], L[j]] for all combinations of k and j by representing the number of learning samples belonging to each group S[k] of 1) using the first matrix 20, representing the number of learning samples belonging to each group L[j] of 2) using the second matrix 30, and obtaining the result matrix 40 by computing the product of the first matrix 20 and the second matrix 30 in the information processing apparatus 2000.

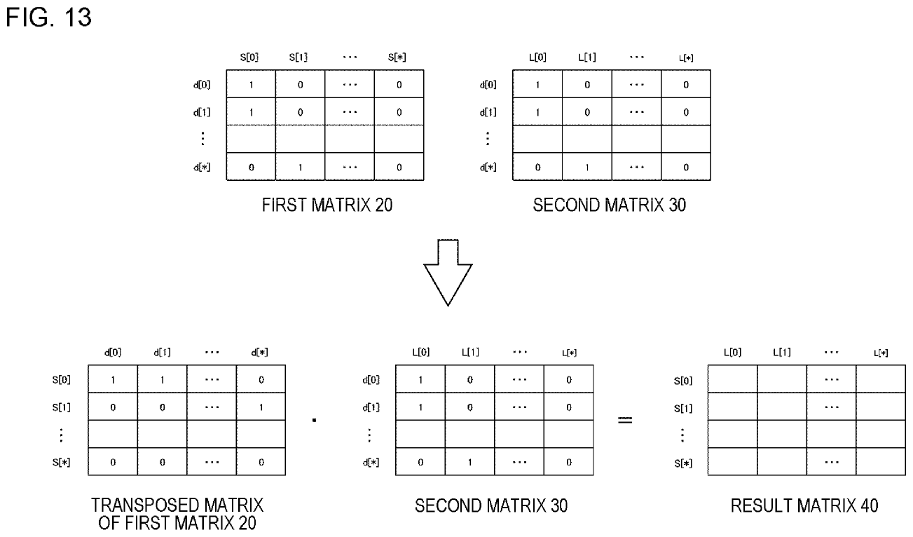

Therefore, the information processing apparatus 2000 generates a matrix representing the learning sample group S[k], in which each learning sample is included, as the first matrix 20. In addition, the information processing apparatus 2000 generates a matrix representing a label L[j], which is attached to each learning sample, as the second matrix 30. Further, the information processing apparatus 2000 computes the product of the first matrix 20 and the second matrix 30 generated in this manner. As a result, the result matrix 40 indicating C[s[k], L[j]] for all combinations of k and j is generated. FIG. 13 is a diagram illustrating computation of the result matrix 40 indicating C[S[k], L[j]]. In FIG. 13, a scalar product of the transposed matrix of the first matrix 20 and the second matrix 30 is computed, thereby generating the result matrix 40 indicating the number of data 10, which belongs to the learning sample group S[k] and to which the label L[j] is given, in the k-th row and the j-th column.

As above, according to the information processing apparatus 2000, the computation of the number of appearances of the label, which is necessary to compute the information gain D in learning of the decision tree, is realized as the matrix operation. Therefore, it is possible to perform parallel processing on the computation of the number of appearances of the label at high speed. Accordingly, it is possible to learn the decision tree at high speed.

<<Case of Using Non-Zero Factor>>

In the usage example, the number C[S, L[j]] of appearances of each label is divided by the total number N of learning samples based on Equation (3) and Equation (4). Here, in a case where a value of 1 is replaced with a value of 1/N in any of the first matrix 20 and the second matrix 30 used for computation of C[S, L[j]], each element of the result matrix 40 computed as the product of the first matrix 20 and the second matrix 30 is a value obtained by dividing the number of appearances of each label by N. As above, in a case where each element of the result matrix 40 is scheduled to be divided by the same value of N, the information processing apparatus 2000 may set the value of 1/N instead of the value of 1 in any of the first matrix 20 and the second matrix 30, instead of dividing each element of the result matrix 40 by N. In this manner, it is possible to omit the division.

<<Omission of Learning Samples and Labels>>

In a course of constructing the decision tree, there is a case where some attributes, threshold values, labels, or learning samples are excluded from consideration. Here, the information processing apparatus 2000 may generate the first matrix 20 after excluding some learning sample groups or may generate the second matrix 30 after excluding some labels.

<<Batch Processing of Plurality of Division Patterns>>

In order to decide optimal division, it is necessary to compute the information gain D for each of all division patterns. It is assumed that the information gain in a certain division pattern p is denoted as D[p], and a k-th learning sample group generated in the division pattern p is denoted as S[p][k]. In order to compute the information gain for all the division patterns, it is necessary to compute C[S[p][k], L[j]] for all combinations of k and j for each division pattern p.

The information processing apparatus 2000 may realize a process of computing C[S[p][k], L[j]] for a plurality of (for example, all) the division patterns p by using one product operation. Specifically, it is possible to realize collective generation of the first matrix 20, which is generated for one division pattern in the above-described example, for the plurality of division patterns.

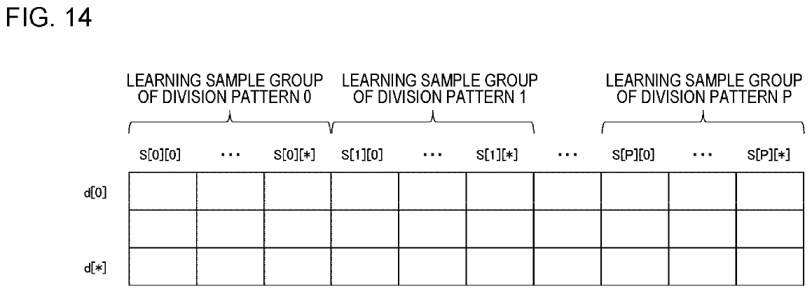

FIG. 14 is a diagram illustrating the first matrix 20 collectively generated for the plurality of division patterns. The first matrix 20 in FIG. 14 indicates the learning sample, to which each learning sample belongs, for a learning sample group generated in each of the plurality of division patterns. The learning sample belongs any of the learning sample group in each of the plurality of division patterns.

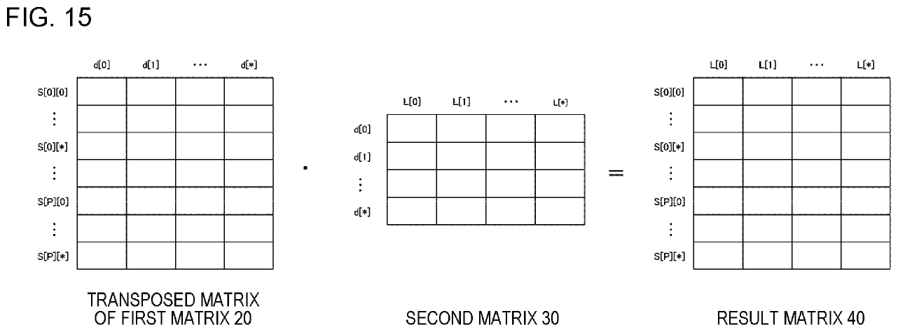

The information processing apparatus 2000 computes the product of the first matrix 20 and the second matrix 30 generated in this manner. In this manner, one result matrix 40 indicating C[S[p][k], [j]] is generated for all the combinations of k and j in the plurality of division patterns. FIG. 15 is a diagram illustrating an aspect in which C[S[p][k], L[j]] is indicated for the plurality of division patterns in one result matrix 40.

Note that, it is not necessary to collectively compute C[S[p][k], L[j]] for all the division patterns, and C[S[p][k], L[j]] may be collectively computed for arbitrary two or more division patterns. For example, it is conceivable that a division pattern, which can be decided to be not the optimal division pattern using another method, is not included in the first matrix 20.

### Second Example Embodiment

<Overview>

As described above, it is general that one variable is assigned to each element of the matrix by representing a matrix as a two-dimensional array in the computer program. In contrast, in an information processing apparatus 2000 of a second example embodiment, one variable is assigned to a plurality of elements of the first matrix 20 and the second matrix 30. A value which may be taken by each element of the first matrix 20 or the second matrix 30 is either the zero factor or the non-zero factor. Therefore, it is sufficient to prepare one bit for each element of the matrix.

Therefore, the information processing apparatus 2000 according to the present example embodiment allocates one bit to each element of the first matrix 20 and the second matrix 30. Specifically, the information processing apparatus 2000 realizes the matrix as a two-dimensional array of integers, and assigns different elements of the matrix to a plurality of bits forming one integer. Hereinafter, an integer, in which the different elements of the matrix are assigned to the respective bits, is referred to as a bit vector integer, and an array of the bit vector integers is referred to as a bit vector integer array. In addition, a matrix, in which one element of the matrix is assigned to each element of the two-dimensional array of integers, is referred to as an integer array.

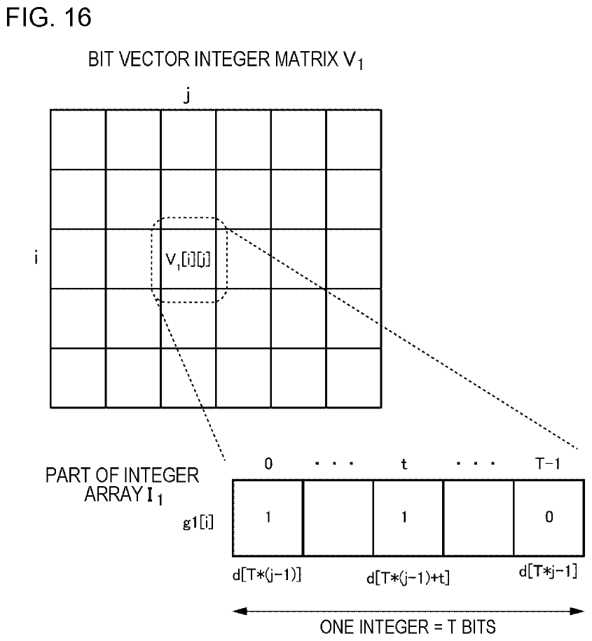

FIG. 16 is a diagram illustrating a correspondence relationship between the first matrix 20 realized as a bit vector integer array V1 and the first matrix 20 realized as an integer array I1. In FIG. 16, a size of the bit vector integer is T bits. Each bit of a leading element V1[0][0] of the bit vector integer array V1 stores values of I1[0][0] to I1[0][T−1] of the integer array I1. In addition, each bit of V[i][j] stores values of I1[i][T*(j−1)] to I1[i][T*j−1]. Note that, in FIG. 16, both the bit vector integer array V1 and the integer array I1 indicate information on the data 10 which are different from each other in a column direction, and indicates information on the groups which are different from each other in a row direction.

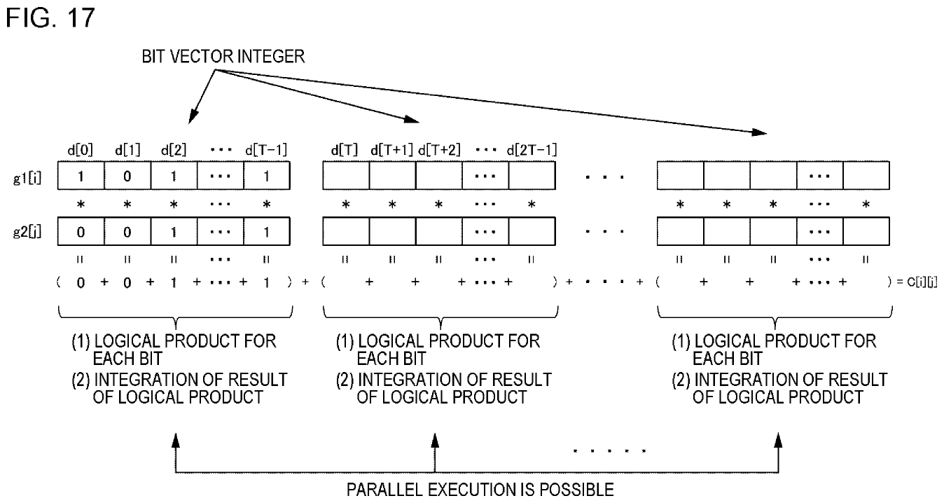

The information processing apparatus 2000 according to the second example embodiment realizes the first matrix 20 and the second matrix 30 as the bit vector integer arrays, respectively, and realizes a product thereof using a bit operation. FIG. 17 is a diagram illustrating a method of realizing the product of the first matrix 20 and the second matrix 30 using the bit operation. As illustrated in FIG. 17, it is possible to realize computation of the number C[i][j] of data 10 belonging to the i-th group g1[i] of the first reference and belonging to the j-th group g2[j] of the second reference by performing an operation between relevant bit vector integers between the first matrix 20 and the second matrix 30 and by adding a result of the operation. Further, it is possible to realize the operation between the bit vector integers by performing, on the bit vector integer of the first matrix 20 and the bit vector integer of the second matrix 30, two processes of 1) computing a logical product for relevant bits and 2) counting up a bit having a value of 1 in the bit vector integer obtained as a result of the computation. The operation of 2) is referred to as population count or bit count.

Here, it is possible to realize the operation 1) by using a single instruction in many processors. In addition, a processor that realizes the operation 2) using a single instruction exists. Accordingly, it is possible to realize the computation of C[i][j] at high speed by using the processor that realizes the operation 1) and the operation 2) using the single instruction. Note that, even in a case where the operation 2) is not realized by using the single instruction in the processor, it is possible to execute the operation at high speed by using a known algorithm such as a divide-and-conquer method.

Furthermore, it is possible to independently execute the operation between the bit vector integers performed between the first matrix 20 and the second matrix 30. Therefore, it is possible to realize the computation of C[i][j] at high speed by performing the parallel processing on the operation between the bit vector integers.

<Example of Functional Configuration>

A functional configuration of the information processing apparatus 2000 according to the second example embodiment is represented in FIG. 4, similarly to, for example, the functional configuration of the information processing apparatus 2000 according to the example embodiment. The information processing apparatus 2000 according to the second example embodiment has the same function as that of the information processing apparatus 2000 according to the first example embodiment, except for points particularly mentioned.

<Example of Hardware Configuration>

A hardware configuration of the information processing apparatus 2000 according to the second example embodiment is represented in FIG. 5, similarly to, for example, the hardware configuration of the information processing apparatus 2000 according to the first example embodiment. However, the storage device 1080 of the computer 1000 that realizes the information processing apparatus 2000 according to the second example embodiment stores a program module that realizes the function of the information processing apparatus 2000 according to the second example embodiment.

<Process Flow>

An overall flow of a process performed by the information processing apparatus 2000 according to the second example embodiment is, for example, represented in FIG. 6, similarly to a case of the information processing apparatus 2000 according to the first example embodiment.

<Method of Generating First Matrix 20>

The first matrix generation unit 2040 according to the present example embodiment generates the first matrix 20 as the bit vector integer array. Hereinafter, the first matrix 20 realized as the bit vector integer array is expressed as a “first bit vector integer array V1”, and the first matrix 20 realized as the integer array is expressed as a “first integer array I1”. The correspondence relationship between V1 and I1 is as illustrated in FIG. 16.

Here, in an example of FIG. 16, it is assumed that a rear side of the bit vector integer (a side on which a value oft increases) is handled as a higher order. In this case, it is possible to compute a value of V1[i][j], that is, a value of an integer obtained by storing the value of the first integer array corresponding to each bit of V1[i][j] based on the following Equation (5). Note that, in a case where a front side of the bit vector integer (a side on which the value of t decreases) is handled as the higher order, an exponent may be changed from t to T−1−t.

$${V}_{1} [ i ] [ j ] = {\sum }_{t = 0}^{T - 1} {2}^{t} * {I}_{1} [ i ] [ T * ( j - 1 ) + t ] \qquad ( 5 )$$

Note that, a case exists where the total number of groups of the first reference is not a multiple of T. In this case, for example, the first matrix generation unit 2040 performs zero padding on a last column of each row of the first bit vector integer array.

<Method of Generating Second Matrix 30>

The second matrix generation unit 2060 generates the second matrix 30 as the bit vector integer array. Hereinafter, the second matrix 30 realized as the integer array is also expressed as a second integer array I2, and the second matrix 30 realized as the bit vector integer array is also expressed as a second bit vector integer array V2.

A method of generating the second matrix 30 as the bit vector integer array is the same as a method of generating the first matrix 20 as the bit vector integer array. The following Equation (6) represents the correspondence relationship between the second integer array I2 and the second bit vector integer array V2.

$${V}_{2} [ i ] [ j ] = {\sum }_{t = 0}^{T - 1} {2}^{t} * {I}_{2} [ i ] [ T * ( j - 1 ) + t ] \qquad ( 6 )$$

<Method of Generating Result Matrix 40>

The product computation unit 2080 generates the result matrix 40 by computing the product of the first matrix 20 realized as the bit vector integer array and the second matrix 30 realized as the bit vector integer array, that is, the product of the first bit vector integer array and the second bit vector integer array.

As described with reference to FIG. 17, the computation of the product of the first matrix 20 and the second matrix 30 is realized by a process of 1) computing one integer by computing a logical product of relevant bits, and 2) counting up one bit for the computed integer, on the relevant bit vector integers. Specifically, the number C[i][j] of data 10 belonging to the i-th group of the first reference and belonging to the j-th group of the second reference is computed based on the following Equation (7).

$$C [ i ] [ j ] = {\sum }_{k} popcount ( {V}_{1} [ i ] [ k ] \& {V}_{2} [ j ] [ k ] ) \qquad ( 7 )$$

Here, “&” is an operator that operates a logical product between corresponding bits of both operands and outputs an integer decided by arrangement of bits obtained as a result of the operation. In addition, popcount (x) is a function of computing the total number of 1 for bits forming the integer x.

Hereinabove, the example embodiments of the present invention have been described with reference to the drawings. However, the example embodiments are merely examples of the present invention, and various configurations other than the above can be adopted.

Although some or all of the above example embodiments may be described as in the following supplementary notes, the example embodiments are not limited to below.

1. An information processing apparatus including:

an acquisition unit which acquires a plurality of data,

a first matrix generation unit which generates a first matrix representing which group each of the data belongs to in a classification according to a first reference;

a second matrix generation unit which generates a second matrix representing which group each of the data belongs to in a classification according to a second reference; and

a product computation unit which computes, for each combination of groups of the first reference and groups of the second reference, the number of the data belonging to the combination by computing a scalar product of the first matrix and the second matrix.

2. The information processing apparatus of 1,

in which each column of the first matrix corresponds to one of the groups, which are different from each other, of the first reference,

in which each row of the first matrix indicates, for one of the data which are different from each other, a non-zero factor only in a column corresponding to the group, to which the one of the data belongs, of the first reference, and indicates a zero factor in the other columns,

in which each column of the second matrix corresponds to one of the groups, which are different from each other, of the second reference,

in which each row of the second matrix indicates, for one of the data which are different from each other, the non-zero factor only in a column corresponding to the group, to which the one of the data belongs, of the second reference, and indicates the zero factor in the other columns, and

in which the product computation unit computes a scalar product of a transposed matrix of the first matrix and the second matrix.

3. The information processing apparatus of 1,

in which each row of the first matrix corresponds to each of the groups, which are different from each other, of the first reference,

in which each column of the first matrix indicates, for each of the data, which are different from each other, a non-zero factor only in a column corresponding to the group, to which the each of the data belongs, of the first reference, and indicates a zero factor in the other columns,

in which each column of the second matrix corresponds to each of the groups, which are different from each other, of the second reference,

in which each row of the second matrix indicates, for the each of the data which are different from each other, the non-zero factor only in a row corresponding to the group, to which the each of the data belongs, of the second reference, and indicates the zero factor in the other rows, and

in which the product computation unit computes a scalar product of the first matrix and the second matrix.

4. The information processing apparatus of 3,

in which each element of the first matrix and the second matrix is an integer represented by a plurality of bits,

in which, in bits of the same row in the first matrix, only a bit corresponding to the group, to which data corresponding to the row belongs, of the first reference is 1 and the other bits are 0,

in which, in bits of the same row in the second matrix, only a bit corresponding to the group, to which data corresponding to the row belongs, of the second reference is 1 and the other bits are 0, and

in which the computation of the scalar product by the product computation unit includes a process of computing an integer by computing a logical product of bits in the same order for mutually corresponding elements of the first matrix and the second matrix, and integrating the number of bits having a value of 1 in the computed integers.

5. The information processing apparatus of any one of 1 to 4, further including a single instruction multiple data (SIMD)-type processor, in which at least one of parallel processing of generating the first matrix, parallel processing of generating the second matrix, and parallel processing of computing the scalar product is executed by using the SIMD-type processor.

6. The information processing apparatus of any one of 1 to 5, in which the data is a learning sample used to learn a model in machine learning.

7. A control method executed by a computer, the method including:

an acquisition step of acquiring a plurality of data;

a first matrix generation step of generating a first matrix representing which group each of the data belongs to in a classification according to a first reference;

a second matrix generation step of generating a second matrix representing which group each of the data belongs to in a classification according to a second reference; and

a product computation step of computing, for each combination of groups of the first reference and groups of the second reference, the number of the data belonging to the combination by computing a scalar product of the first matrix and the second matrix.

8. The control method of 7,

in which each column of the first matrix corresponds to one of the groups, which are different from each other, of the first reference,

in which each row of the first matrix indicates, for one of the data which are different from each other, a non-zero factor only in a column corresponding to the group, to which the one of the data belongs, of the first reference, and indicates a zero factor in the other columns,

in which each column of the second matrix corresponds to one of the groups, which are different from each other, of the second reference,

in which each row of the second matrix indicates, for one of the data which are different from each other, the non-zero factor only in a column corresponding to the group, to which the one of the data belongs, of the second reference, and indicates the zero factor in the other columns, and

in which, in the product computation step, a scalar product of a transposed matrix of the first matrix and the second matrix is computed.

9. The control method of 7,

in which each row of the first matrix corresponds to each of the groups, which are different from each other, of the first reference,

in which each column of the first matrix indicates, for each of the data, which are different from each other, a non-zero factor only in a column corresponding to the group, to which the each of the data belongs, of the first reference, and indicates a zero factor in the other columns,

in which each column of the second matrix corresponds to each of the groups, which are different from each other, of the second reference,

in which each row of the second matrix indicates, for the each of the data which are different from each other, the non-zero factor only in a row corresponding to the group, to which the each of the data belongs, of the second reference, and indicates the zero factor in the other rows, and

in which, in the product computation step, a scalar product of the first matrix and the second matrix is computed.

10. The control method of 9,

in which each element of the first matrix and the second matrix is an integer represented by a plurality of bits,

in which, in bits of the same row in the first matrix, only a bit corresponding to the group, to which data corresponding to the row belongs, of the first reference is 1 and the other bits are 0,

in which, in bits of the same row in the second matrix, only a bit corresponding to the group, to which data corresponding to the row belongs, of the second reference is 1 and the other bits are 0, and

in which the computation of the scalar product in the product computation step includes a process of computing an integer by computing a logical product of bits in the same order for mutually corresponding elements of the first matrix and the second matrix, and integrating the number of bits having a value of 1 in the computed integers.

11. The control method of any of 7 to 10,

in which a single instruction multiple data (SIMD)-type processor is included, and in which at least one of parallel processing of generating the first matrix, parallel processing of generating the second matrix, and parallel processing of computing the scalar product is executed by using the SIMD-type processor.

12. The control method of any one of 7 to 11, in which the data is a learning sample used to learn a model in machine learning.

13. A program for causing a computer to execute each step of the control method of any one of 7 to 12.

This application claims priority based on Japanese Patent Application No. 2018-015598 filed on Jan. 31, 2018, the entire disclosure of which is incorporated herein.

What is claimed is:

1. An information processing apparatus comprising:
an acquisition unit which acquires a plurality of data;
a first matrix generation unit which generates a first matrix representing which group each of the data belongs to in a classification according to a first reference;
a second matrix generation unit which generates a second matrix representing which group each of the data belongs to in a classification according to a second reference; and
a product computation unit which computes, for each combination of groups of the first reference and groups of the second reference, the number of the data belonging to the combination by computing a scalar product of the first matrix and the second matrix.

2. The information processing apparatus according to claim 1,
wherein each column of the first matrix corresponds to one of the groups, which are different from each other, of the first reference,
wherein each row of the first matrix indicates, for one of the data which are different from each other, a non-zero factor only in a column corresponding to the group, to which the one of the data belongs, of the first reference, and indicates a zero factor in the other columns,
wherein each column of the second matrix corresponds to one of the groups, which are different from each other, of the second reference,
wherein each row of the second matrix indicates, for one of the data which are different from each other, the non-zero factor only in a column corresponding to the group, to which the one of the data belongs, of the second reference, and indicates the zero factor in the other columns, and
wherein the product computation unit computes a scalar product of a transposed matrix of the first matrix and the second matrix.

3. The information processing apparatus according to claim 1,
wherein each row of the first matrix corresponds to each of the groups, which are different from each other, of the first reference,
wherein each column of the first matrix indicates, for each of the data, which are different from each other, a non-zero factor only in a column corresponding to the group, to which the each of the data belongs, of the first reference, and indicates a zero factor in the other columns,
wherein each column of the second matrix corresponds to each of the groups, which are different from each other, of the second reference,
wherein each row of the second matrix indicates, for the each of the data which are different from each other, the non-zero factor only in a row corresponding to the group, to which the each of the data belongs, of the second reference, and indicates the zero factor in the other rows, and
wherein the product computation unit computes a scalar product of the first matrix and the second matrix.

4. The information processing apparatus according to claim 3,
wherein each element of the first matrix and the second matrix is an integer represented by a plurality of bits,
wherein, in bits of the same row in the first matrix, only a bit corresponding to the group, to which data corresponding to the row belongs, of the first reference is 1 and the other bits are 0,
wherein, in bits of the same row in the second matrix, only a bit corresponding to the group, to which data corresponding to the row belongs, of the second reference is 1 and the other bits are 0, and
wherein the computation of the scalar product by the product computation unit includes a process of computing an integer by computing a logical product of bits in the same order for mutually corresponding elements of the first matrix and the second matrix, and integrating the number of bits having a value of 1 in the computed integers.

5. The information processing apparatus according to claim 1, further comprising:
a single instruction multiple data (SIMD)-type processor,
wherein at least one of parallel processing of generating the first matrix, parallel processing of generating the second matrix, and parallel processing of computing the scalar product is executed by using the SIMD-type processor.

6. The information processing apparatus according to claim 1,
wherein the data is a learning sample used to learn a model in machine learning.

7. A control method executed by a computer, the method comprising:
an acquisition step of acquiring a plurality of data;
a first matrix generation step of generating a first matrix representing which group each of the data belongs to in a classification according to a first reference;
a second matrix generation step of generating a second matrix representing which group each of the data belongs to in a classification according to a second reference; and
a product computation step of computing, for each combination of groups of the first reference and groups of the second reference, the number of the data belonging to the combination by computing a scalar product of the first matrix and the second matrix.

8. The control method according to claim 7,
wherein each column of the first matrix corresponds to one of the groups, which are different from each other, of the first reference,
wherein each row of the first matrix indicates, for one of the data which are different from each other, a non-zero factor only in a column corresponding to the group, to which the one of the data belongs, of the first reference, and indicates a zero factor in the other columns,
wherein each column of the second matrix corresponds to one of the groups, which are different from each other, of the second reference,
wherein each row of the second matrix indicates, for one of the data which are different from each other, the non-zero factor only in a column corresponding to the group, to which the one of the data belongs, of the second reference, and indicates the zero factor in the other columns, and
wherein, in the product computation step, a scalar product of a transposed matrix of the first matrix and the second matrix is computed.

9. The control method according to claim 7,
wherein each row of the first matrix corresponds to each of the groups, which are different from each other, of the first reference,
wherein each column of the first matrix indicates, for each of the data, which are different from each other, a non-zero factor only in a column corresponding to the group, to which the each of the data belongs, of the first reference, and indicates a zero factor in the other columns,
wherein each column of the second matrix corresponds to each of the groups, which are different from each other, of the second reference,
wherein each row of the second matrix indicates, for the each of the data which are different from each other, the non-zero factor only in a row corresponding to the group, to which the each of the data belongs, of the second reference, and indicates the zero factor in the other rows, and
wherein, in the product computation step, a scalar product of the first matrix and the second matrix is computed.

10. The control method according to claim 9,
wherein each element of the first matrix and the second matrix is an integer represented by a plurality of bits,
wherein, in bits of the same row in the first matrix, only a bit corresponding to the group, to which data corresponding to the row belongs, of the first reference is 1 and the other bits are 0,
wherein, in bits of the same row in the second matrix, only a bit corresponding to the group, to which data corresponding to the row belongs, of the second reference is 1 and the other bits are 0, and
wherein the computation of the scalar product in the product computation step includes a process of computing an integer by computing a logical product of bits in the same order for mutually corresponding elements of the first matrix and the second matrix, and integrating the number of bits having a value of 1 among the computed integers.

11. The control method according to claim 7,
wherein a single instruction multiple data (SIMD)-type processor is included, and
wherein at least one of parallel processing of generating the first matrix, parallel processing of generating the second matrix, and parallel processing of computing the scalar product is executed by using the SIMD-type processor.

12. The control method according to claim 7,
wherein the data is a learning sample used to learn a model in machine learning.

13. A non-transitory computer readable medium storing a program for causing a computer to execute each step of a control method, the method comprising:
an acquisition step of acquiring a plurality of data;
a first matrix generation step of generating a first matrix representing which group each of the data belongs to in a classification according to a first reference;
a second matrix generation step of generating a second matrix representing which group each of the data belongs to in a classification according to a second reference; and
a product computation step of computing, for each combination of groups of the first reference and groups of the second reference, the number of the data belonging to the combination by computing a scalar product of the first matrix and the second matrix.
